(19) United States
(12) Patent Application Publication
(10) Pub. No.: US 2016/0179949 A1
(43) Pub. Date: Jun. 23, 2016

(54) Larger preloaded IPod or MP3 player

(71) Applicant: Michael Lewis Moravitz, Fairfax, VA (US)

(72) Inventor: Michael Lewis Moravitz, Fairfax, VA (US)

(21) Appl. No.: 14/998,437

(22) Filed: Jan. 4, 2016

(51) Int. Cl. G06F 17/30

(52) U.S. Cl. CPC G06F 17/30778

(57) ABSTRACT

A Larger Capacity Preloaded IPod or other MP3 Player—up to 16 GB currently—can be made to sell large collections of a particular musical artist, genre, or era and to get around Internet accessibility problems.

Preloaded IPods should have larger memory to hold a much bigger collection, up to the 16 GB size.

Other MP3 manufacturers should consider this as well. Music, particularly popular varieties, constantly changes, and Internet access is overstated as to ability to purchase and download music. Hence, of course, the need for a preloaded IPod. However, preloaded collections might include a particular artist or a particular genre, such as classical or older classics in another genre such as rock and roll, in which the selection would probably not change and could be larger. For example, the albums of the Beatles or Rolling Stones might be included on a preloaded, larger capacity IPod or the Best of the 60s, 70s, etc. Many music lovers might not specialize in a genre but might like the Best of the Classics or Jazz or some other genre. The utility of the preloaded IPod or other type of MP3 player has not been fully realized. The limited capacity of the preloaded IPod is a problem for those who want the newest music, to change their selections, and are without Internet access or enough download capacity. See my previous patent application for a Store Downloader Ser. No. 14/120,022, in which music would be purchased from a large capacity MP3 player, as a way around this problem. Preloaded MP3 players—together with those that are blank and loaded by the owner—may form the basis of a collection in the future. See my previous patent application for a Home Sound System with MP3 Plug-in (USB cable input) Ser. No. 29/463,808 (originally a design application; petitioning to make utility).

1) Builds on patents for preloaded IPods;

2) And other MP3 players.
